(19) United States
(12) Patent Application Publication
(10) Pub. No.: US 2021/0033555 A1
(43) Pub. Date: Feb. 4, 2021

(54) METHOD FOR CALIBRATING AN ANALYTICAL MEASURING DEVICE AND MEASURING POINT FOR ANALYZING A PROCESS MEDIUM AND FOR CALIBRATING AN ANALYTICAL MEASURING DEVICE

(71) Applicant: Endress+Hauser Conducta GmbH+Co. KG, Gerlingen (DE)

(72) Inventors: Torsten Pechstein, Radebeul (DE); Michael Hanko, Dresden (DE); Dagmar Kaschuba, Gerlingen (DE); Erik Hennings, Freiberg (DE); Thomas Pfauch, Leipzig (DE); Stephan Jugert, Dresden (DE); Jens Vettermann, Grossweitzschen (DE)

(21) Appl. No.: 16/942,547

(22) Filed: Jul. 29, 2020

(30) Foreign Application Priority Data
Jul. 29, 2019 (DE) 10 2019 120 442.9

(51) Int. Cl. G01N 27/08; G01N 27/07

(52) U.S. Cl. CPC G01N 27/08; G01N 27/07

(57) ABSTRACT

The invention relates to a method for calibrating an analytical measuring device in a measuring point. The method includes closing the outlet valve so that no process medium is discharged, closing the inlet valve so that no additional process medium is fed into the measuring point and a volume of process medium is in the measuring point, feeding a predetermined volume of the calibration medium into the measuring point, circulating the calibration medium by means of the pump so that the flow circuit is generated and the calibration medium flows against the analytical measuring device, detecting a first measured for a calibration, repeating the steps of feeding the calibration medium into the measuring point, circulating the calibration medium, and detecting a measured value for the calibration, and evaluating the measured values and performing the calibration.

### REFERENCE TO RELATED APPLICATION

The present application is related to and claims the priority benefit of German Patent Application No. 10 2019 120 442.9, filed on Jul. 29, 2019, the entire contents of which are incorporated herein by reference.

### TECHNICAL FIELD

The present disclosure relates to various methods for calibrating an analytical measuring device and to a measuring point for analyzing a process medium and for calibrating an analytical measuring device.

### BACKGROUND

In analytical measurement technology, especially in the fields of water management and environmental analysis and in industry, for example in food technology, biotechnology and pharmaceuticals, as well as for various laboratory applications, measurands, such as pH value, conductivity or the concentration of analytes, such as ions or dissolved gases in a gaseous or liquid measurement medium, are vitally important. These measurands can be detected and/or monitored, for example, by means of analytical measuring devices, especially, electrochemical sensors, such as potentiometric, amperometric, voltammetric or coulometric sensors, or else conductivity sensors.

In the field of water management, especially, in the monitoring of drinking water, ballast water in ships, water in swimming pools, so-called disinfection sensors are used, which are suitable for measuring different parameters, e.g. chlorine, chlorine dioxide, bromine, hydrogen peroxide, etc. Such sensors are used when the content of the respective species has to be monitored in order to ensure an antibacterial state of the process systems.

Disinfection sensors also show a dependence of the measured value on the inflow of the sensor membrane. For reliable measurement results, it is therefore important to know the inflow and to be able to adjust it precisely.

Disinfection sensors are usually part of a measuring point or even of a control loop. Measuring points can be designed, for example, as flow fittings or as screw-in fittings. Flow fittings are preferred over screw-in fittings since the flow at the sensor membrane can be adjusted therewith.

Disinfection sensors usually operate according to an electrochemical measuring principle. By electrochemical reaction, temperature influences or by the chemical process conditions themselves, the sensor experiences a shift of the measurement signal, which can be reflected in a changed sensor characteristic.

In order to ensure sufficient measurement accuracy, it is necessary to calibrate the sensor and to adjust the zero point and/or slope.

Conventional disinfection sensors are removed from the fitting for calibration and, in a separate vessel, reference materials for the zero point and/or slope determination are applied to the disinfection sensors. Another possibility of calibration consists in sampling at the fitting and measuring said sample via a reference measurement method. In the case of chlorine, with the so-called colorimetric DPD test. As a result, an offset or slope correction of the disinfection sensor is only possible with a considerable outlay.

However, the DPD test method has a non-negligible measurement error which can be transmitted to the disinfection sensor during its adjustment.

A plurality of sometimes complex work steps is thus required for the calibration of a disinfection sensor. These work steps represent a risk of error for an incorrect adjustment of the disinfection sensor, which may not be detected by the user during operation of the disinfection sensor.

Moreover, the previously known calibration method has the disadvantage that during calibration, the disinfection sensor is usually exposed to other flow conditions, other temperatures, other compositions of the water matrix with respect to the reference solution than in the process flow fitting, as a result of which measurement errors can be generated.

Moreover, the removal of the disinfection sensor from the fitting represents an additional outlay for the operator of the measuring point.

### SUMMARY

It is, therefore, an object of the present disclosure to provide a calibration method which avoids the aforementioned disadvantages.

This object is achieved by a method for calibrating an analytical measuring device in a measuring point according to claim 1.

The method according to the present disclosure comprises at least the following steps:
Providing a measuring point through which a process medium flows and an analytical measuring device, wherein the measuring point has an inlet valve, an outlet valve, an analysis container, a dosing container, and a pump,

wherein the inlet valve is connected to a first inlet for feeding in the process medium, to a second inlet for feeding in a calibration medium, to the analysis container, and to the dosing container,

wherein the outlet valve is connected to a drain, the analysis container, and the dosing container,

wherein the inlet valve, the analysis container, the dosing container, and the outlet valve are connected to one another in such a way that a flow circuit can be realized in the measuring point,

wherein the pump is arranged in such a way that it is suitable for generating the flow circuit,

wherein the analytical measuring device is arranged in the analysis container and is in contact with the process medium,
Closing the outlet valve so that no process medium is discharged through the outlet valve to the drain,
Closing the inlet valve so that no additional process medium is fed from the first inlet into the measuring point and a predetermined volume of process medium is located in the measuring point,
Feeding a predetermined volume of the calibration medium into the measuring point through the inlet valve from the second inlet,
Circulating the calibration medium by means of the pump so that the flow circuit is generated and the calibration medium flows against the analytical measuring device, wherein a predetermined flow velocity of the calibration medium is set by the pump,
Detecting a first measured value by means of the analytical measuring device for a calibration,
Repeating at least once the steps of feeding a predetermined volume of the calibration medium into the measuring point, circulating the calibration medium by means of the pump, and detecting a further measured value for the calibration of the analytical measuring device,
Evaluating the first measured value and the subsequent measured values and performing the calibration of the analytical measuring device based on the evaluation of the first measured value and the subsequent measured values.

The method according to the present disclosure for calibrating an analytical measuring device enables particularly precise calibration of an analytical measuring device in the process installation state. As a result of the repeated feeding of the analyte, the concentration of the analyte in the process medium does not have to be known but is determined by the increase in concentration of the analyte in the process medium.

According to one embodiment of the present disclosure, before the step of closing the inlet valve, a step of measuring the process medium is carried out by means of the analytical measuring device and a step of measuring the flow velocity of the process medium is carried out by a flow meter, and wherein, during the step of circulating the calibration medium by means of the pump, the predetermined flow velocity of the calibration medium is adjusted such that the flow velocity of the calibration medium corresponds to the measured flow velocity of the process medium.

A more accurate calibration is possible by calibration at the same flow velocity as in the measuring operation.

According to one embodiment of the present disclosure, the analytical measuring device has a cross-sensitivity to the calibration medium, wherein the step of calibrating the analytical measuring device is a calibration based on the cross-sensitivity to the calibration medium.

It is thus possible to calibrate different sensors simultaneously by means of one calibration medium.

According to one embodiment of the present disclosure, the calibration medium contains a standard metal solution. Thus, the calibration is particularly simple.

According to one embodiment of the present disclosure, the calibration medium comprises demineralized water and a stock solution of an analyte.

As a result, the calibration medium is only generated in situ and at the point in time when it is needed, whereby the autonomy duration of the calibration method is increased.

The object according to the present disclosure is furthermore achieved by a measuring point for analyzing a process medium and for calibrating an analytical measuring device according to claim 6.

The measuring point according to the present disclosure comprises:

an inlet valve, an outlet valve, an analysis container, a dosing container, and a pump with a regulatable delivery rate,

wherein the inlet valve is connected to a first inlet for feeding in a process medium, to a second inlet for feeding in a calibration medium, to the analysis container, and to the dosing container,

wherein the outlet valve is connected to a drain, the analysis container, and the dosing container,

wherein the inlet valve, the analysis container, the dosing container, and the outlet valve are connected to one another in such a way that a flow circuit can be realized in the measuring point,

wherein the pump is arranged in such a way that it is suitable for generating the flow circuit,

wherein the analytical measuring device is arranged in the analysis container in such a way that the flow circuit can flow against the analytical measuring device.

According to one embodiment of the present disclosure, the measuring point further comprises a bypass channel which connects the first inlet and the drain in order to guide a part of the process medium from the first inlet past the analysis container and the dosing container to the drain, wherein a first drive means of the pump is arranged in the bypass channel and a second drive means of the pump is arranged in the flow circuit, wherein the first drive means is suitable for driving the second drive means.

The measuring point is thus suitable for driving the first drive means currentlessly via the second drive means. The measuring point is thus also suitable, by means of the first drive means and the second drive means, for mapping the flow velocity prevailing in the bypass channel onto the flow circuit in the measuring point.

According to one embodiment of the present disclosure, the inlet valve is configured as a multi-way valve.

According to one embodiment of the present disclosure, the analytical measuring device is a chlorine sensor and/or a chlorine dioxide sensor and/or a bromine sensor and/or a pH sensor and/or a conductivity sensor and/or a dissolved oxygen sensor.

### BRIEF DESCRIPTION OF THE DRAWINGS

The present disclosure is explained in more detail on the basis of the following description of the figures. They show:

FIG. 1: a schematic depiction of a measuring point according to the present disclosure,

FIG. 2: a schematic depiction of an embodiment of the measuring point from FIG. 1 with a bypass channel.

### DETAILED DESCRIPTION

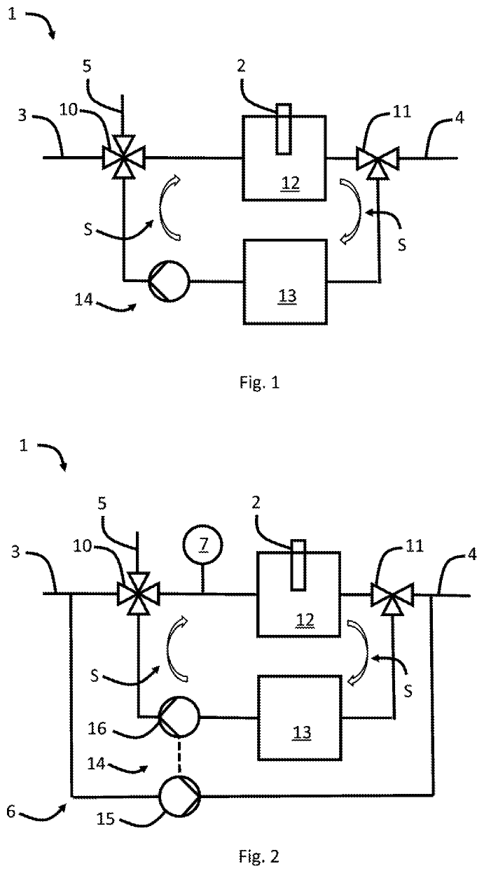

FIG. 1 shows a schematic depiction of a measuring point 1 according to the present disclosure. According to one embodiment, the measuring point 1 is a flow-through measuring point. The measuring point 1 comprises an inlet valve 10, an outlet valve 11, an analysis container 12, a dosing container 13, and a pump 14. An analytical measuring device 2 is arranged in the analysis container 12.

The inlet valve 10 is connected to a first inlet 3 for feeding in a process medium, to a second inlet 5 for feeding in a calibration medium, to the analysis container 12, and to the dosing container 13.

The outlet valve 11 is connected to a drain 4, the analysis container 12, and the dosing container 13. The inlet valve 10 is preferably configured as a multi-way valve, for example as a four-way valve. In one embodiment, the inlet valve 10 can be designed in such a way that the four paths of the inlet valve 10 are arranged in a manner spatially separated.

The inlet valve 10, the analysis container 12, the dosing container 13, and the outlet valve 11 are connected to one another in such a way that a flow circuit S can be realized in the measuring point 1. The pump 14 is arranged in such a way that it is suitable for generating the flow circuit S. In FIG. 1, the pump 14 is arranged between the inlet valve 10 and the dosing container 13. However, the pump 14 can also be arranged at other points within the flow circuit S. The pump 14 has a regulatable delivery rate. The analytical measuring device 2 is arranged in the analysis container 12 in such a way that the flow circuit S can flow against the analytical measuring device 2.

The analytical measuring device 2 is, for example, a chlorine sensor and/or a chlorine dioxide sensor and/or a bromine sensor and/or a pH sensor and/or a conductivity sensor and/or a dissolved oxygen sensor.

FIG. 2 shows a second embodiment of the measuring point 1 with a so-called bypass channel 6. The bypass channel 6 connects the first inlet 3 and the drain 4 in order to guide the process medium from the first inlet 3 to the drain 4. The bypass channel 6 enables a portion of the process medium to be guided from the first inlet 3 past the analysis container 12 and the dosing container 13 directly to the drain 4. A first drive means 15 of the pump 14 is arranged in the bypass channel 6 and a second drive means 16 of the pump is arranged in the flow circuit S. The first and second drive means 15, 16 is, for example, a paddle wheel or a turbine type. The first drive means 15 is suitable for driving the second drive means 16. The first drive means 15 is connected to the second drive means 16 via a drive shaft, for example. A transmission means, for example a transmission, can also be arranged between the first drive means 15 and the second drive means 16 in order to achieve different rotational speeds of the two drive means 15, 16.

FIG. 2 furthermore shows a flow meter 7 arranged between the inlet valve 10 and the analysis container 12. The flow meter 7 can, of course, be arranged at other positions in the flow circuit S. The flow meter 7 enables a flow velocity to be measured. Of course, the flow meter 7 can also be used in the measuring points 1 depicted in FIG. 1 or FIG. 3 (not shown there). Alternatively or additionally, the pump 14 can be used to measure the flow velocity.

The method for calibrating the analytical measuring device 2 by standard addition is described below.

In a first step, the measuring point 1 described above with reference to FIG. 1 is provided. The measuring point 1 is provided in such a way that the process medium flows through the measuring point 1. In other words, the measuring point 1 is in operation. The process medium thus flows from the first inlet 3 through the measuring point 1 to the drain 4.

The process medium is guided from the first inlet 3 through the analysis container 12 to the outlet 4. In this case, the inlet valve 10 is switched in such a way that the inlet valve 10 communicates with the first inlet 3 and the analysis container 12, and the outlet valve 11 is switched in such a way that the outlet valve 11 communicates only with the analysis container 12 and the drain 4.

In a next step, the outlet valve 11 is closed so that no process medium is discharged through the outlet valve 11 to the drain 4.

The inlet valve 10 is then closed so that no additional process medium is fed from the first inlet 3 into the measuring point 1. This means that a predetermined amount of process medium is located between the inlet valve 10 and the outlet valve 11.

The step of closing the outlet valve 11 can also be performed after the step of closing the inlet valve 10 so that a predetermined amount that is less than the maximum amount of process medium receivable by the measuring point is contained in the measuring point.

Optionally, before the step of closing the outlet valve 11 and of closing the inlet valve 10, a step of measuring the process medium by means of the analytical measuring device 2 and a step of measuring the flow velocity of the process medium by means of a flow meter 7 can be performed.

Subsequently, a predetermined volume of the calibration medium is fed into the measuring point 1 through the second inlet 5 of the inlet valve 10 into the measuring point 1. A standard metal solution is used as the calibration medium, for example.

Alternatively, demineralized water and a stock solution of an analyte can be used as the calibration medium. In this alternative, the feeding step comprises feeding the demineralized water separately from the feeding of the stock solution of an analyte. The term “separately” is understood here to mean that the demineralized water and the stock solution of an analyte are fed or combined into the measuring point 1 at separate times. Alternatively, the demineralized water and the stock solution of an analyte can also be combined from locally separate containers shortly before being fed into the measuring point 1 and can thus be fed into the measuring point 1 at the same time. The advantage of a time-separated feeding or local separation and combining only shortly before feeding into the measuring point 1 is that the calibrant provided in this way has significantly longer durability than the combined calibrant or known calibrants, such as the standard metal solution.

Next, the calibration medium and the process medium are circulated, i.e., mixed, by means of the pump 14 so that the flow circuit S is generated and the calibration medium-process medium mixture flows against the analytical measuring device 2. A predetermined flow velocity of the calibration medium-process medium mixture is set by the pump 14.

As indicated in FIG. 1 by the arrows, the flow circuit S produced by the pump 14 runs in the same direction as the flow direction of the process medium in the measuring operation. The flow circuit S runs from the inlet valve 10, via the analysis container 12, via the outlet valve 11, via the dosing tank 13, via the pump 14 to the analysis container 12. The inlet valve 10 and the outlet valve 11 are opened in such a way that the analysis container 12 and the dosing container 13 fluidically communicate with one another.

The predetermined flow velocity is preferably set in such a way that the flow velocity of the calibration medium-process medium mixture corresponds to the flow velocity of the process medium measured by the flow meter. Accurate calibration is thus possible since the operating conditions of the analytical measuring device 2, i.e., the exact flow velocity, of the measuring operation are also taken into account during the calibration operation.

In a next step, the analytical measuring device 2 detects a first measured value for a calibration of the analysis measuring device 2 by standard addition.

Next, the steps of feeding a predetermined volume of the calibration medium into the measuring point 1, circulating the calibration medium and the process medium by means of the pump 14, and detecting a further measured value for the calibration of the analytical measuring device 2 are repeated at least once.

The first measured value and the subsequent measured values are then evaluated and a calibration of the analytical measuring device 2 is carried out by standard addition based on the evaluation of the first measured value and the subsequent measured values.

FIG. 2 shows a variant of the calibration method described with reference to FIG. 1. In this case, the first drive means 15 of the pump 14 is driven by the second drive means 16 of the pump 14 during the step of circulating the calibration medium-process medium mixture. The flow velocity of the calibration medium in the flow circuit S is set here by setting a transmission ratio of the first drive means 15 and second drive means 16 which are mechanically connected to one another. In this variant, the flow meter 7 is used to check the flow velocity in the flow circuit S.

Further advantages of the calibration method described are that a faster and more accurate measurement is possible in the event of shock disinfections.

1. A method for calibrating an analytical measuring device in a measuring point, the method comprising:
providing a measuring point through which a process medium flows and an analytical measuring device, wherein the measuring point has an inlet valve, an outlet valve, an analysis container, a dosing container, and a pump, wherein the inlet valve is connected to a first inlet for feeding in the process medium, to a second inlet for feeding in a calibration medium, to the analysis container, and to the dosing container, wherein the outlet valve is connected to a drain, the analysis container, and the dosing container, wherein the inlet valve, the analysis container, the dosing container, and the outlet valve are connected to one another in such a way that a flow circuit (S) can be realized in the measuring point, wherein the pump is arranged in such a way that it is suitable for generating the flow circuit, and wherein the analytical measuring device is arranged in the analysis container and is in contact with the process medium;
closing the outlet valve so that no process medium is discharged through the outlet valve to the drain;
closing the inlet valve so that no additional process medium is fed from the first inlet into the measuring point and a predetermined volume of process medium is located in the measuring point;
feeding a predetermined volume of the calibration medium into the measuring point through the inlet valve from the second inlet;
circulating the calibration medium by means of the pump so that the flow circuit is generated and the calibration medium flows against the analytical measuring device wherein a predetermined flow velocity of the calibration medium is set by the pump;
detecting a first measured value by means of the analytical measuring device for a calibration;
repeating at least once the steps of feeding a predetermined volume of the calibration medium into the measuring point, circulating the calibration medium by means of the pump, and detecting a further measured value for the calibration of the analytical measuring device; and
evaluating the first measured value and the subsequent measured values and performing the calibration of the analytical measuring device based on the evaluation of the first measured value and the subsequent measured values.

2. The method according to claim 1, wherein before the step of closing the inlet valve, a step of measuring the process medium by means of the analytical measuring device and a step of measuring the flow velocity of the process medium by means of a flow meter is performed, and
wherein in the step of circulating the calibration medium by means of the pump, the predetermined flow velocity of the calibration medium is set such that the flow velocity of the calibration medium corresponds to the measured flow velocity of the process medium.

3. The method according to claim 1, wherein the analytical measuring device has a cross-sensitivity to the calibration medium and the step of calibrating the analytical measuring device is a calibration based on the cross-sensitivity to the calibration medium.

4. The method according to claim 1, wherein the calibration medium contains a standard metal solution.

5. The method according to claim 1, wherein the calibration medium comprises demineralized water and a stock solution of an analyte.

6. A measuring point for analyzing a process medium and for calibrating an analytical measuring device, comprising:
an inlet valve, an outlet valve, an analysis container, a dosing container, and a pump with a regulatable delivery rate,
wherein the inlet valve is connected to a first inlet for feeding in a process medium, to a second inlet for feeding in a calibration medium, to the analysis container, and to the dosing container,
wherein the outlet valve is connected to a drain, the analysis container, and the dosing container,
wherein the inlet valve, the analysis container, the dosing container, and the outlet valve are connected to one another such that a flow circuit can be realized in the measuring point,
wherein the pump is arranged in such a way that it is suitable for generating the flow circuit, and
wherein the analytical measuring device is arranged in the analysis container such that the flow circuit (S) can flow against the analytical measuring device.

7. The measuring point according to claim 6, wherein the measuring point further comprises a bypass channel which connects the first inlet and the drain to guide a part of the process medium from the first inlet past the analysis container and the dosing container to the drain, wherein a first drive means of the pump is arranged in the bypass channel and a second drive means of the pump is arranged in the flow circuit, wherein the first drive means is suitable for driving the second drive means.

8. The measuring point according to claim 6, wherein the inlet valve is configured as a multi-way valve.

9. The measuring point according to claim 6, wherein the analytical measuring device is an analyzer.
